(19) United States
(12) Patent Application Publication
(10) Pub. No.: US 2010/0308057 A1
(43) Pub. Date: Dec. 9, 2010

(54) BEVERAGE CONTAINERS AND COMPONENTS THEREOF

(76) Inventor: Harry Hart, Hemet, CA (US)

Correspondence Address: HPF, P.O. BOX 4442, CHESTERFIELD, MO, 63006-4442, US

(21) Appl. No.: 12/776,501

(22) Filed: May 10, 2010

Related U.S. Application Data
(60) Provisional application No. 61/176,938, filed on May 10, 2009.
(60) Provisional application No. 61/290,220, filed on Dec. 27, 2009.

(51) Int. Cl. B65D 25/08; B67D 7/06

(52) U.S. Cl. 220/506; 222/81

(57) ABSTRACT

Beverage containers are provided that include two chambers, with a first chamber containing a volume of water and a second chamber containing a powder. The second chamber is at least partially disposed in the first chamber and is sufficiently elongated to be at least partially submerged in the water contained therein. The second chamber further comprises a top portion that includes a first window, and a bottom portion that includes a second window. The first window and second window may be mechanically converted into an open position to cause the powder to mix with the water to create a solution that may be consumed by a user. Beverage container caps are also disclosed, which allow the first and second window to be mechanically opened by a user.

### CROSS-REFERENCE TO RELATED APPLICATIONS

This application claims priority to U.S. provisional patent application Ser. No. 61/176,938, filed May 10, 2009, and U.S. provisional patent application Ser. No. 61/290,220, filed Dec. 27, 2009, both of which are incorporated herein by reference.

### FIELD OF THE INVENTION

The field of the present invention relates to beverage containers and components thereof. More particularly, the field of the present invention relates to beverage containers, and components thereof, which are configured to separately store a powder substance and a volume of water, which a user may selectively cause to be mixed prior to consumption.

### BACKGROUND OF THE INVENTION

Most beverages that are sold to consumers are pre-formulated and exist in a ready-to-drink state. For example, in the case of beverages that are formulated by mixing soluble dried ingredients (including minerals and vitamins) with an aqueous solvent, such beverages are often produced by mixing the ingredients with the aqueous solvent to create the consumable beverage, packaging the beverage in a container, and then shipping the filled beverage container to retailers or consumers. Of course, this approach typically requires that certain preservatives and/or stabilizers be added to the beverage. In addition, when a significant period of time passes after the ingredients are mixed with the aqueous solvent, and before the beverage is actually consumed, the beverage will often lose its “freshness” and certain components thereof may begin to degrade.

Accordingly, a continuing needs exists for new and improved beverage containers, which allow such dried ingredients to be stored within the container separate and apart from the aqueous solvent, but which allow the two components to be combined and mixed with each other just prior to consumption.

### SUMMARY OF THE INVENTION

According to certain aspects of the present invention, beverage containers are provided that include two chambers, with a first chamber containing a volume of water and a second chamber containing a powder. The second chamber is at least partially disposed in the first chamber and is sufficiently elongated to be at least partially submerged in the water contained in the first chamber. The second chamber further comprises a top portion that includes a first window, and a bottom portion that includes a second window. The first window and second window may be mechanically converted into an open position to cause the powder to mix with the water to create a fresh solution that may be consumed by a user. The invention provides that upon mixing of the powder and water, the beverage container may be inverted to consume the resulting solution, such that the solution passes through both the first and second windows of the second chamber—and through a spout from which the solution may be consumed by a user.

According to additional aspects of the invention, beverage containers are provided which, as described above, include two chambers, with a first chamber containing a volume of water and a second chamber containing a powder. According to such embodiments, the beverage containers further comprise a specialized cap that is adapted to allow the first and second window to be mechanically opened by a user—as described above. More particularly, the cap will preferably include a top surface, a bottom portion which surrounds and is attached to a neck portion of the beverage container, and a middle strip located between the top surface and bottom portion. The invention provides that the middle strip is preferably adapted to be manually torn away from the cap to leave an open space between the top surface and bottom portion. This open space allows the cap to be compressed and forced downwards, which causes the first window and second window to be mechanically converted into an open position, as described above.

According to yet further aspects of the invention, components of the above-mentioned beverage containers are provided. More particularly, for example, the invention encompasses the second chamber of the beverage containers described herein, as well as the specialized cap that is described herein to be adapted to allow the first and second window (of the second chamber) to be mechanically opened by a user.

According to still further aspects of the invention, methods of mixing a dry, soluble ingredient with an aqueous solvent are provided, which methods involve the use of the beverage containers described herein.

The above-mentioned and additional features of the present invention are further illustrated in the Detailed Description contained herein.

### BRIEF DESCRIPTION OF THE FIGURES

FIG. 1 is a side view of the cap of the beverage container described herein.

FIG. 2 is a top, perspective view of the cap of the beverage container described herein.

FIG. 3 is a back side view of the cap of the beverage container described herein.

FIG. 4 is a bottom, perspective view of the cap of the beverage container described herein.

FIG. 5A is a side, cross-sectional view of the cap of the beverage container described herein.

FIG. 5B is a perspective view of another embodiment and type of cap that may be used with the beverage containers described herein.

FIG. 6A is a top, perspective view of the cutting tube of the beverage container described herein.

FIG. 6B is a perspective view of another embodiment and type of cutting tube that may be used with the beverage containers described herein.

FIG. 7 is a side view of the cutting tube of the beverage container described herein.

FIG. 8 is a side view of the cutting tube of the beverage container described herein, which includes a cutout section that reveals the interior portion of the cutting tube and also shows the first cutting element described herein.

FIG. 9 is a side, cross-sectional view of the cutting tube of the beverage container described herein.

FIG. 10 is a top, perspective view of the cutting tube of the beverage container described herein, which includes a cutout section that reveals the interior portion of the cutting tube and also shows the first cutting element described herein.

FIG. 11 is a side view of the second chamber (powder chamber) of the beverage container described herein.

FIG. 12 is a top, perspective view of the second chamber (powder chamber) of the beverage container described herein.

FIG. 13 is a perspective view of another embodiment of a second chamber (powder chamber) that may be used in the beverage containers described herein.

FIG. 14 is a side, cross-sectional view of the beverage container described herein.

FIG. 15 is a side, cross-sectional view of the top portion of the beverage container described herein, which shows the middle strip of the cap still connected between the top surface and bottom portion of the cap.

FIG. 16 is a side, cross-sectional view of the top portion of the beverage container described herein, which shows the middle strip of the cap having been removed therefrom.

FIG. 17 is a side, cross-sectional view of the top portion of the beverage container described herein, which shows the middle strip of the cap having been removed therefrom and the top surface of the cap forced downwards toward the interior of the bottle, such that the first and second windows described herein have been converted into an open position.

FIG. 18 is an elevated view of the exterior portion of an assembled beverage container, as described herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

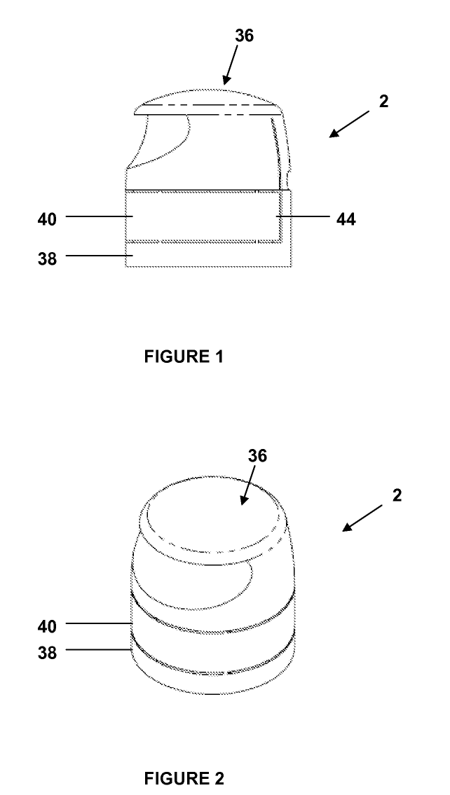

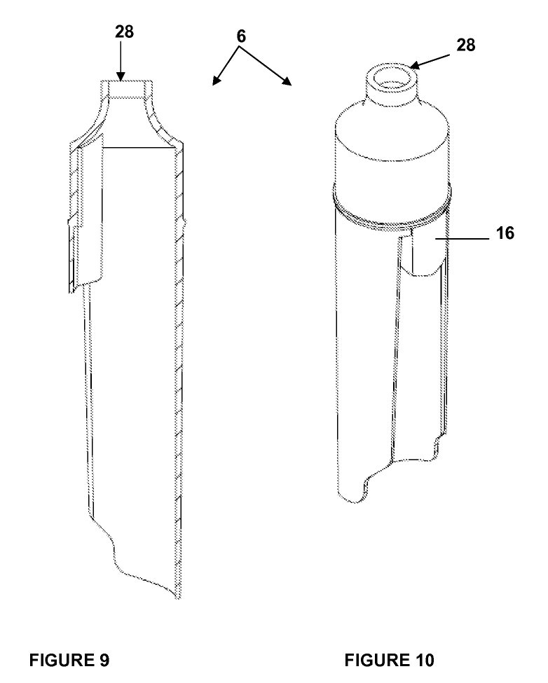

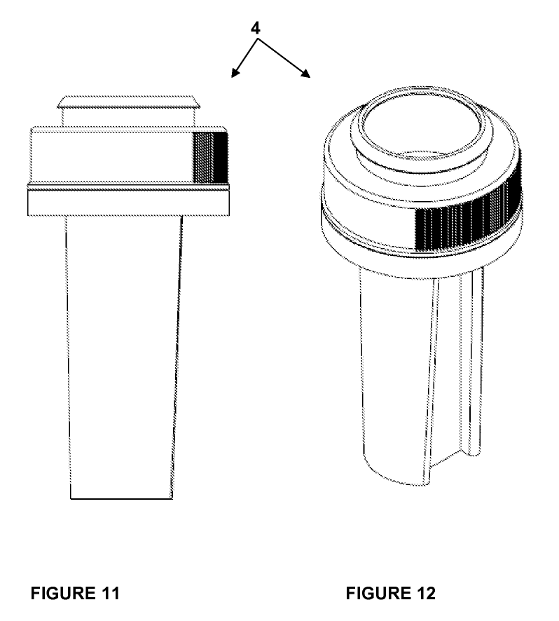

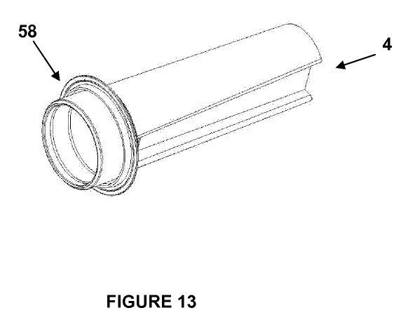

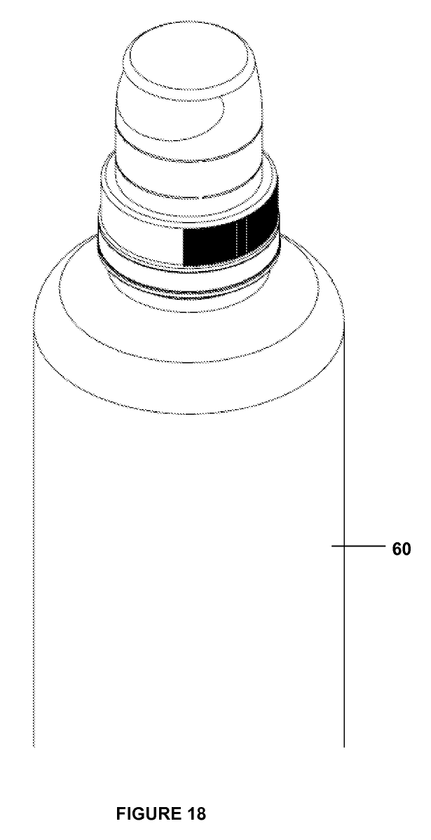

Referring to FIGS. 1-18, the present invention encompasses certain beverage containers and components thereof. According to certain embodiments, the beverage containers include a cap 2, a first chamber 60, a second chamber 4, and a cutting tube 6. The invention provides that the first chamber 60 will preferably contain a volume of water, whereas the second chamber 4 will preferably contain a powder. The water that is contained in the first chamber 60 may comprise pure water (or substantially pure water) or, in other embodiments, the water may further comprise other solutes, such as vitamins, minerals, or other agents. As used herein, the term “powder,” as used in relation to the substance that is contained within the second chamber 4, should be given an expansive meaning. For example, the “powder” may contain soluble sheets, crystals, flakes, clumps, beads, and other solid or semi-solid agents. Preferably, however, the powder will be soluble in the water contained within the first chamber 60. The invention provides that the powder may comprise any of a variety of substances, such as minerals, vitamins, proteins, biologics, small molecules, flavorings, colorants, desiccated forms of natural extracts, or other agents which may be desirably mixed with the water contained within the first chamber 60 to create a beverage.

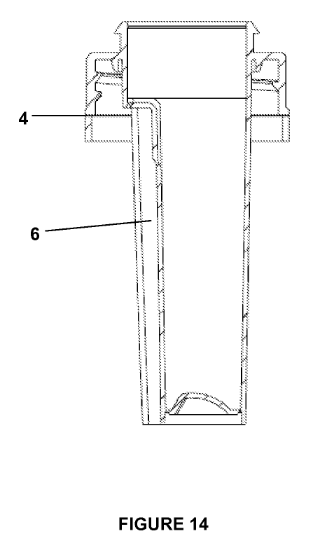

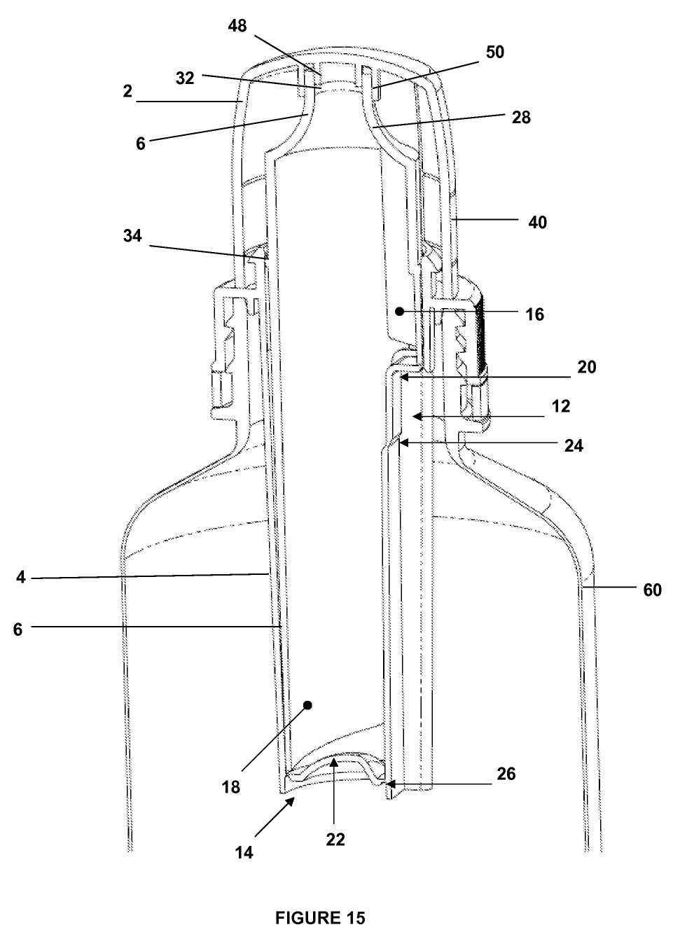

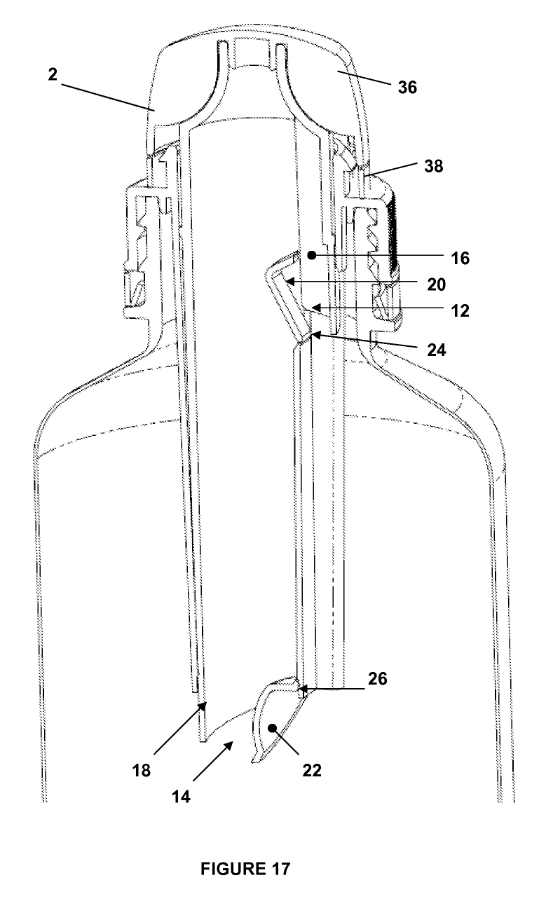

The invention provides that the combined second chamber 4 and cutting tube 6 is at least partially, if not fully, disposed in the first chamber 60. The invention provides that the beverage containers described herein are assembled, in part, by disposing the cutting tube 6 into the second chamber 4, as shown in FIG. 14. The combined second chamber 4 and cutting tube 6 is then disposed into the first chamber 60. The second chamber 4 is sufficiently elongated to be at least partially submerged in the water (not shown) contained within the first chamber 60. The second chamber 4 will preferably include a top portion, which includes a first window 12 (FIGS. 15 and 17). Similarly, the second chamber 4 will preferably include a bottom portion, which includes a second window 14 (FIGS. 15 and 17). As illustrated in FIG. 17, the first window 12 and second window 14 may be mechanically converted into an open position, as described herein, such that the powder included within the second chamber 4 is allowed to mix with the water contained within the first chamber 60. The first window 12 and second window 14 may be located along a “line of weakness,” which is illustrated as line “A” in FIG. 8 (relative to its location to the adjacent cutting tube 4), which may facilitate the opening of the first window 12 and second window 14.

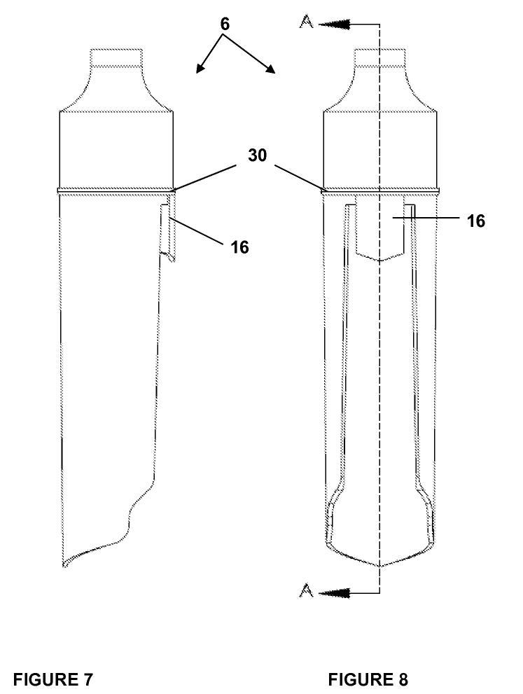

Referring now to FIGS. 7, 8, 10, and 17, the cutting tube 6 further comprises a first cutting element 16 located above the first window 12 and a second cutting element 18 located above the second window 14. As illustrated in FIG. 17, the invention provides that the first cutting element 16 and second cutting element 18 may be mechanically forced (downwards) into the first window 12 and second window 14, respectively, to convert the first window 12 and second window 14 into an open position. In certain preferred embodiments of the invention, the first window 12 and the second window 14 both comprise a door which is forced into an interior portion of the second chamber 4. More particularly, and referring to FIGS. 15 and 17, the first cutting element 16 may be forced into the door 20 covering the first window 12, whereas the second cutting element 18 may be forced into the door 22 covering the second window 14, such that door 20 is forced into the interior portion of the second chamber 4 and that door 22 is forced into the interior portion of the first chamber 60. Because the doors 20,22 are forced into the interior portion of the second chamber 4 and first chamber 60, respectively, instead of outside of the second chamber 4, water will more easily flow through the windows 12,14 to mix with the powder contained therein (such design also prevents the neck portion of the container from impeding the opening of the doors 20,22). The door 20 and door 22 will preferably comprise a hinge point 24 and hinge point 26, respectively, which facilitate the movement of the doors 20,22 upon being contacted by the first and second cutting elements 16,18.

The invention provides that the cutting tube 6 will further comprise a spout 28. The invention provides that, upon the powder contained within the second chamber 4 mixing with the water contained within the first chamber 60, a solution (a drinkable beverage) will be created. As such, upon a user inverting the beverage container, i.e., turning the spout 28 towards the user's mouth, the solution is allowed to exit the beverage container through the first window 12 and the second window 14, and then through the spout 28. Still further, referring to FIGS. 7, 8 and 15, the invention provides that the second chamber 4 will preferably include a compression seal 30 (shown in FIGS. 7 and 8 relative to its location adjacent to the cutting tube 4), located near the top portion of the second chamber 4. In addition, the cutting tube 6 may be provided with a cap seal 32, located just beneath the exit point of the spout 28, and a sliding radial seal 34 (FIG. 15). The foregoing seals may be employed to provide additional means for preventing the water contained within the first chamber 60 from penetrating the interior portion of the second chamber 4 when the first window 12 and second window 14 are in a closed position. These seals may be induction seals, foil seals, or combinations thereof.

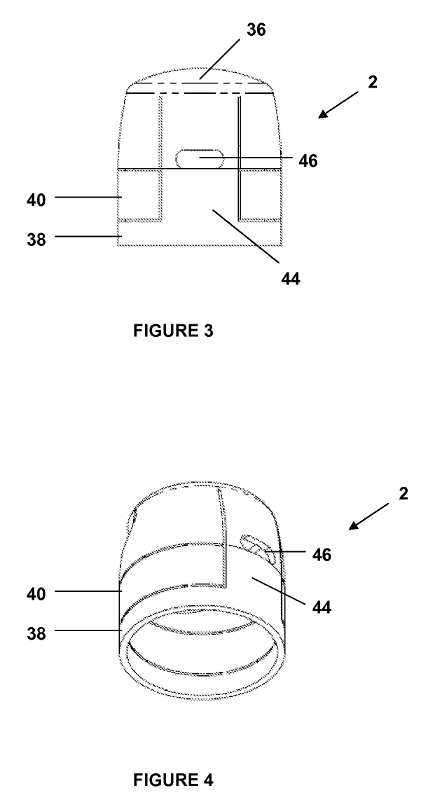

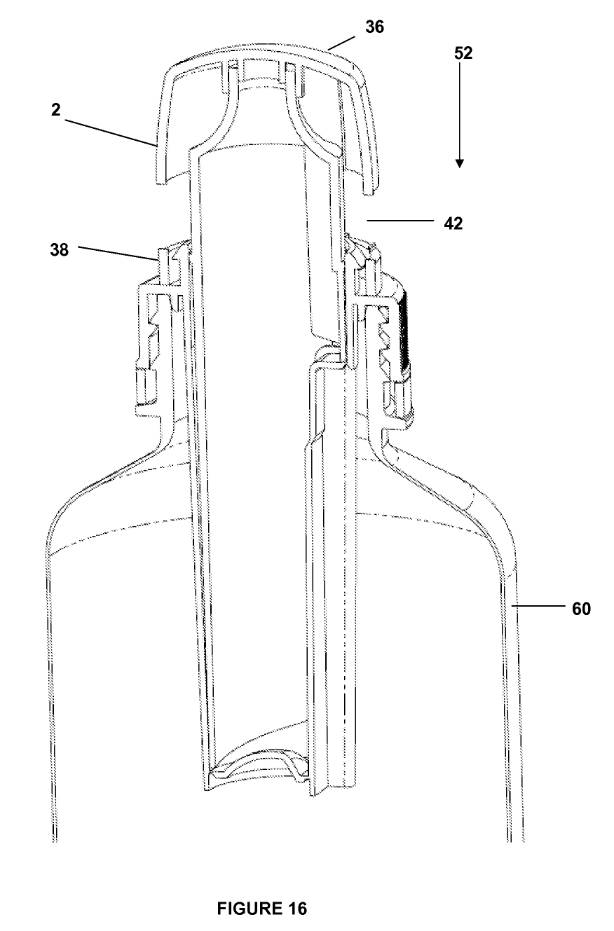

According to certain preferred embodiments of the present invention, the beverage containers further include a novel bottle cap. More particularly, referring to FIGS. 1-5A, the cap includes a top surface 36, a bottom portion 38 which surrounds and is attached to a neck portion of the beverage container, and a middle strip 40 located between the top surface 36 and bottom portion 38. The invention provides that the middle strip 40 is adapted to be manually torn away from the cap to leave an open space 42 between the top surface 36 and bottom portion 38, which is illustrated in FIG. 16. The middle space 42 may vary in size; however, non-limiting examples of such middle space 42 may comprise a 5-15 mm gap, such as an 11 mm gap. The middle strip 40 may comprise perforated edges, or other mechanical means, to allow the middle strip 40 to be conveniently removed from the cap by a user. The invention provides that the cap further comprises a flexible hinge 44 located between, and which flexibly connects, the top surface 36 and bottom portion 38 of the cap. More particularly, the hinge 44 is created upon manually tearing away the middle strip 40. As shown in FIGS. 3 and 4, the hinge 44 may comprise a strip which is contiguously formed with and exists between the bottom portion 38 and top surface 36 of the cap. The invention provides that the flexible hinge 44 is adapted to buckle and allow the cap to be forced downwards—when force is applied to the top surface 36 thereof. The invention provides that the flexible hinge 44 may, optionally, comprise an aperture 46, which may facilitate the ability of the hinge 44 to buckle in this manner (by making the hinge 44 more flexible).

As explained above, the bottom portion 38 of the cap, which surrounds the neck portion of the beverage container, remains attached to the neck portion of the beverage container, even after the middle strip 40 is removed. As such, the bottom portion 38 will serve as an anchor, and will allow the cap to be folded backwards in a bi-modal fashion (along the hinge 44)—i.e., away from the spout 28 of the container, while remaining attached to the container. Thus, after the contents of the first chamber 60 and second chamber 4 are mixed, and ready for consumption, the cap may be moved away from the spout 28 for access thereto, while allowing the cap to remain attached to the beverage container (such that it may also be placed back over the spout 28 if a user wishes to preserve certain portions of the beverage for a later time).

According to certain embodiments of the invention, the cap may further comprise a plug 48 which is configured to be disposed into the spout 28 (FIG. 15). Still further, the cap may comprise a wall 50 which surrounds the spout 28, which serves to further secure the cap to the beverage container. As illustrated in FIGS. 1-3, the top surface 36 of the cap exhibits a relatively convex surface, and preferably includes a relatively large diameter (such as between 28-38 mm), such that the top surface 36 of the cap will accommodate and be comfortable to a person's hand. Such configuration is preferred insofar as, in order to cause the contents of the first and second chambers 60,4 to mix, a person must apply a manual force to the top surface 36 of the cap. Thus, the slightly convex and relatively large diameter of the top surface 36 of the cap will serve to spread out the load across a person's hand.

In view of the foregoing, the beverage container described herein may be operated as follows. First, the middle strip 40 of the cap is removed (torn away). By tearing away the middle strip 40, a space 42 (FIG. 16) is created between the top surface 36 and bottom portion 38 of the cap, whereby the space 42 surrounds the entire perimeter of the cap, with the exception of the hinge 44. Next, a manual downwards force 52 is applied to the top surface 36 of the cap (FIG. 16). This downwards force will cause the top surface 36 of the cap to move towards the bottom portion 38 of the cap, and to substantially close the space 42, as shown in FIG. 17. This downwards force will further cause the cutting tube 6 to move downwards, and cause the first cutting element 16 to be forced into the door 20 covering the first window 12, and the second cutting element 18 to be forced into the door 22 covering the second window 14 of the second chamber 4, such that both doors 20,22 are forced open, as also illustrated in FIG. 17. At this point, the powder contained within the second chamber 4 will be allowed to mix with the water contained in the first chamber 60. The position of the first and second cutting elements 16,18 will cause the doors 20,22 to remain within the interior portion or area of the second chamber 4, such that the windows 12,14 remain open to allow a continuous flow water into the second chamber 4. The beverage container may be agitated or shaken to facilitate the solublization of the powder into the water. Finally, the cap may be folded backwards along the hinge 44, away from and to expose the spout 28, such that the solution (beverage) may then be consumed by a user.

The invention provides that the various parts of the beverage container described herein may be constructed from a variety of different materials, such as plastics, polymers, elastomers, paper, or combinations of the foregoing. In addition, the size and volume of the containers may be adapted to suit the intended composition or final drink product. Similarly, the neck portion of the beverage container may be adjusted as needed, in order to achieve the desired aesthetics and/or pour rates. For example, the neck portion may have a diameter of 26.7 mm, 28 mm, 38 mm, 43 mm, or a custom diameter (designed for a particular consumer or application).

Among the many unique features of the present invention is its ability to allow a user to consume the freshly prepared beverage, without having to remove the second chamber 4—which originally houses the powder described herein. In addition, the presence of two separate windows, i.e., the first and second window 12,14, through which water may flow to mix with the powder, expedites the process of causing the powder to dissolve into the water. In addition, the invention provides that the middle strip 40 not only prevents the unintentional compression of the cap (and subsequent mixing of the powder and water), it also provide a tamper resistant feature, insofar as any unwanted tampering with the contents of the beverage container must be preceded by the removal of the middle strip 40. As such, any unwanted tampering would be evidenced by a disrupted middle strip 40.

According to yet further embodiments of the invention, components of the above-mentioned beverage containers are provided. More particularly, for example, the invention encompasses (as separate components) the second chamber 4 of the beverage containers described herein, as well as the cap that is described herein to be adapted to allow the first and second window 12,14 (of the second chamber 4) to be mechanically opened by a user.

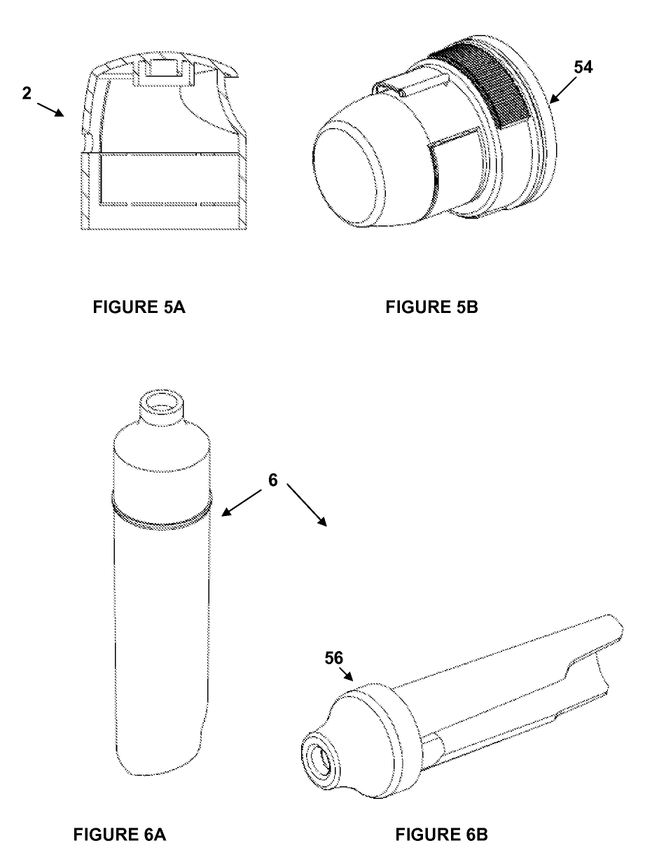

In addition to the designs described thus far, the invention provides certain alternative embodiments and designs. For example, referring to FIG. 5B, the invention provides that a modified version of the cap 2 described herein may be used, such as a cap having a threaded portion (not shown) on the interior, perimeter portion 54 thereof, which may be reversibly attached to the drinking spout portion of the beverage bottle. Still further, according to such alternative embodiments and referring to FIG. 6B, the beverage container may include a cutting tube 6 that comprises a rim or ring 56 located near the spout portion thereof, which is configured to rest adjacent to and on top of a corresponding rim or ring 58 included on a separate second chamber 4 (powder chamber), which is then disposed in the first chamber 60 described herein (which contains a volume of liquid). The invention provides that a seal ring may be located at or near the rim or ring 56 of the cutting tube 6, such that when disposed in the second chamber 4, a desirably tight seal is achieved between the cutting tube 6 and second chamber 4—at the location where the corresponding rings 58,56 meet. According to such embodiments, the cap 2, second chamber 4, cutting tube 6, and first chamber 60 may be comprised of different materials, which materials may be designed with their intended purpose in mind. For example, the cap 2 may be comprised of a more durable and rigid material, relative to a less rigid material that may be used to construct the first chamber 60.

According to still further embodiments of the invention, methods of mixing a dry, soluble ingredient with an aqueous solvent within a single beverage container are provided, which methods essentially involve the use of the beverage containers described herein.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

What is claimed is:

1. A beverage container which comprises two chambers, wherein a first chamber contains a volume of water and a second chamber contains a powder, wherein the second chamber:
(a) is at least partially disposed in the first chamber and is sufficiently elongated to be at least partially submerged in the water contained within the first chamber;
(b) comprises a top portion which includes a first window; and
(c) comprises a bottom portion which includes a second window, wherein the first window and second window may be mechanically converted into an open position to cause the powder to mix with the water.

2. The beverage container of claim 1, wherein the second chamber further comprises a cutting tube which includes a first cutting element located above the first window and a second cutting element located above the second window, wherein the first cutting element and second cutting element may be mechanically forced into a door which covers the first window and second window, respectively, to convert the first window and second window into an open position.

3. The beverage container of claim 2, wherein a first door which covers the first window, and a second door which covers the second window, are forced into an interior portion of the second chamber when the first cutting element and second cutting element are mechanically forced into the first door and second door, respectively.

4. The beverage container of claim 3, wherein the cutting tube further comprises a spout, wherein upon the powder mixing with the water to create a solution and the container being inverted, the solution is allowed to exit the beverage container through the first window and the second window, and then through the spout.

5. The beverage container of claim 4, which further comprises one or more seals to prevent the water from penetrating the interior portion of the second chamber when the first window and second window are in a closed position.

6. The beverage container of claim 5, wherein the first cutting element and second cutting element may be mechanically forced into the first door and second door, respectively, by applying a downward force to a topside of the beverage container.

7. A beverage container which comprises two chambers, wherein a first chamber contains a volume of water and a second chamber contains a powder, wherein:
(a) the second chamber: (i) is at least partially disposed in the first chamber and is sufficiently elongated to be at least partially submerged in the water contained within the first chamber, (ii) comprises a top portion which includes a first window, and (iii) comprises a bottom portion which includes a second window, wherein the first window and second window may be mechanically converted into an open position to cause the powder to mix with the water; and
(b) the first chamber includes a cap that comprises: (i) a top surface, (ii) a bottom portion which surrounds and is attached to a neck portion of the beverage container, and (iii) a middle strip located between the top surface and bottom portion, wherein the middle strip is adapted to be manually torn away from the cap to leave an open space between the top surface and bottom portion.

8. The beverage container of claim 7, wherein the second chamber further comprises a cutting tube which includes a first cutting element located above the first window and a second cutting element located above the second window, wherein the first cutting element and second cutting element may be mechanically forced into a door which covers the first window and second window, respectively, to convert the first window and second window into an open position.

9. The beverage container of claim 8, wherein a first door which covers the first window, and a second door which covers the second window, are forced into an interior portion of the second chamber when the first cutting element and second cutting element are mechanically forced into the first door and second door, respectively.

10. The beverage container of claim 9, wherein the cutting tube further comprises a spout, wherein upon the powder mixing with the water to create a solution and the container being inverted, the solution is allowed to exit the beverage container through the first window and the second window, and then through the spout.

11. The beverage container of claim 10, which further comprises one or more seals to prevent the water from penetrating the interior portion of the second chamber when the first window and second window are in a closed position.

12. The beverage container of claim 11, wherein the first cutting element and second cutting element may be mechanically forced into the first door and second door, respectively, by applying a downward force to a topside of the beverage container.

13. The beverage container of claim 12, wherein the cap further comprises a flexible hinge located between the top surface and bottom portion thereof, which is created upon manually tearing away the middle strip.

14. The beverage container of claim 13, wherein the flexible hinge is adapted to buckle and allow the cap to be forced downwards when force is applied to the top surface thereof.

15. The beverage container of claim 14, wherein the flexible hinge comprises an aperture which facilitates an ability of the hinge to buckle.

16. The beverage container of claim 15, wherein the bottom portion of the cap which surrounds and is attached to the neck portion of the beverage container allows the cap to be folded backwards and away from a spout of the container, while remaining attached to the container.

17. The beverage container of claim 16, wherein the cap further comprises a plug which is configured to be disposed into the spout of the cutting tube.

18. The beverage container of claim 17, wherein the top surface of the cap exhibits a convex surface to accommodate a person's hand.
